(19) United States
(12) Patent Application Publication
(10) Pub. No.: US 2015/0260874 A1
(43) Pub. Date: Sep. 17, 2015

(54) System and Method for Imaging Subterranean Formations

(71) Applicant: Schlumberger Technology Corporation, Sugar land, TX (US)

(72) Inventors: Yong-Hua Chen, Belmont, MA (US); Dzevat Omeragic, Lexington, MA (US); Tarek M. Habashy, Burlington, MA (US)

(21) Appl. No.: 14/656,641

(22) Filed: Mar. 12, 2015

Related U.S. Application Data
(60) Provisional application No. 61/952,863, filed on Mar. 13, 2014.

(51) Int. Cl. G01V 3/38; E21B 47/12; E21B 49/00

(52) U.S. Cl. CPC G01V 3/38; E21B 49/00; E21B 47/12; E21B 49/005

(57) ABSTRACT

Systems and methods for imaging properties of subterranean formations in a wellbore include a formation sensor for collecting currents injected into the subterranean formations and a formation imaging unit. The formation imaging unit includes a current management unit for collecting data from the currents injected into the subterranean formations and a formation data unit for determining at least one formation parameter from the collected data. The formation imaging unit also includes an inversion unit for determining at least one formation property by inverting the at least one formation parameter. The inversion unit is suitable for generating an inverted standoff image and an inverted permittivity image for comparison with a composite image of the formation imaging unit.

### CROSS REFERENCE TO RELATED APPLICATIONS

This application claims the benefit of U.S. Provisional Application No. 61/952,863, entitled “SYSTEM AND METHOD FOR IMAGING SUBTERRANEAN FORMATIONS,” filed Mar. 13, 2014, the entire disclosure of which is hereby incorporated herein by reference.

### TECHNICAL FIELD

The present invention relates to techniques for performing wellbore operations. More particularly, the present invention relates to techniques for determining characteristics of subterranean formations.

### BACKGROUND

Oil rigs are positioned at wellsites for performing a variety of oilfield operations, such as drilling a wellbore, performing downhole testing and producing located hydrocarbons. Downhole drilling tools are advanced into the earth from a surface rig to form a wellbore. Drilling muds are often pumped into the wellbore as the drilling tool advances into the earth. The drilling muds may be used, for example, to remove cuttings, to cool a drill bit at the end of the drilling tool and/or to provide a protective lining along a wall of the wellbore. During or after drilling, casing is typically cemented into place to line at least a portion of the wellbore. Once the wellbore is formed, production tools may be positioned about the wellbore to draw fluids to the surface.

During drilling, measurements are often taken to determine downhole conditions. In some cases, the drilling tool may be removed so that a wireline testing tool may be lowered into the wellbore to take additional measurements and/or to sample downhole fluids. Once the drilling operation is complete, production equipment may be lowered into the wellbore to assist in drawing the hydrocarbons from a subsurface reservoir to the surface.

The downhole measurements taken by the drilling, testing, production and/or other wellsite tools may be used to determine downhole conditions and/or to assist in locating subsurface reservoirs containing valuable hydrocarbons. Such wellsite tools may be used to measure downhole parameters, such as temperature, pressure, viscosity, resistivity, etc. Such measurements may be useful in directing the oilfield operations and/or for analyzing downhole conditions.

Attempts have been made to measure certain characteristics of a wellbore. However, it may be desirable to provide techniques that enhance downhole fluid and/or downhole formation measurements. Furthermore, techniques may be provided to correct for the effects of mud on downhole imaging and/or measurement. Such techniques may involve accuracy of measurements, optimized measurement processes, operability in a variety of downhole fluids such as conductive and non-conductive muds, flexible measurement and/or analysis, operability in downhole conditions (e.g., at high temperatures and/or pressures), etc.

### SUMMARY

The present invention relates to a formation imaging unit for imaging properties of at least one subterranean formation in a wellbore at a wellsite. The formation imaging unit includes a current management unit for collecting data from at least two currents injected into the at least one subterranean formation, the at least two currents having at least two different frequencies, and a formation data unit for determining at least one formation parameter from the collected data. The formation imaging unit further includes an inversion unit for determining at least one formation property by inverting the at least one formation parameter to provide one or more of an inverted standoff image and an inverted permittivity image.

The present invention relates to a system for imaging properties of at least one subterranean formation in a wellbore at a wellsite. The system comprises a formation sensor for collecting currents injected into the at least one subterranean formation, the formation sensor positionable on a downhole tool deployable into the wellbore and a formation imaging unit. The formation imaging unit includes a current management unit for collecting data from the currents injected into the at least one subterranean formation. The formation imaging unit also includes a data unit for determining a formation parameter, a borehole mud parameter, or both, from the collected data. Furthermore, the formation imaging unit includes an inversion unit for determining at least one formation property by inverting formation parameter, the borehole mud parameter, or both, to provide an inverted standoff image, an inverted permittivity image, or both.

The present invention relates to a method for imaging properties of at least one subterranean formation in a wellbore at a wellsite. The method includes deploying a downhole tool into the wellbore, the downhole tool having a formation sensor thereon and collecting at least two currents sent through the at least one subterranean formation from the formation sensor. The method includes sending formation data from the at least two currents to a formation imaging unit and performing an inversion at the formation imaging unit, wherein performing the inversion comprises generating an inverted standoff image, an inverted permittivity image, or both. The method includes determining at least one formation property with the formation imaging unit, based on the inverted standoff image, the inverted permittivity image, or both.

### BRIEF DESCRIPTION OF THE DRAWINGS

The present embodiments may be better understood, and numerous objects, features, and advantages made apparent to those skilled in the art by referencing the accompanying drawings. These drawings are used to illustrate only typical embodiments of this invention, and are not to be considered limiting of its scope, as the invention may admit to other equally effective embodiments. The figures are not necessarily to scale and certain features and certain views of the figures may be shown exaggerated in scale or in schematic in the interest of clarity and conciseness.

FIG. 1 is a schematic view of a system for imaging properties of one or more subterranean formations having a downhole tool deployable into a wellbore, in accordance with embodiments of the present disclosure.

FIG. 2 is a schematic view of the downhole tool of FIG. 1 depicting the downhole tool with a sensor pad having a formation sensor thereon, in accordance with embodiments of the present disclosure.

FIG. 3 is a longitudinal cross-sectional view of the sensor pad of FIG. 2 taken along line A-A depicting the formation sensor on a face of the sensor pad, in accordance with embodiments of the present disclosure.

FIG. 4 is a longitudinal cross-sectional view of an alternate sensor pad of FIG. 3, in accordance with embodiments of the present disclosure.

FIG. 5 depicts a schematic diagram illustrating a formation imaging unit, wherein the formation imaging unit is for imaging properties of at least one subterranean formations at the wellsite, in accordance with embodiments of the present disclosure.

FIGS. 6-13 are graphical depictions of various outputs created by the formation imaging unit of FIG. 5, in accordance with embodiments of the present disclosure.

FIG. 14 is a flow chart depicting a method of imaging properties of at least one subterranean formation, in accordance with embodiments of the present disclosure.

### DESCRIPTION OF EMBODIMENT(S)

The description that follows includes exemplary apparatus, methods, techniques, and instruction sequences that embody techniques of the present inventive subject matter. However, it is understood that the described embodiments may be practiced without these specific details. Presently preferred embodiments of the invention are shown in the above-identified Figures and described in detail below.

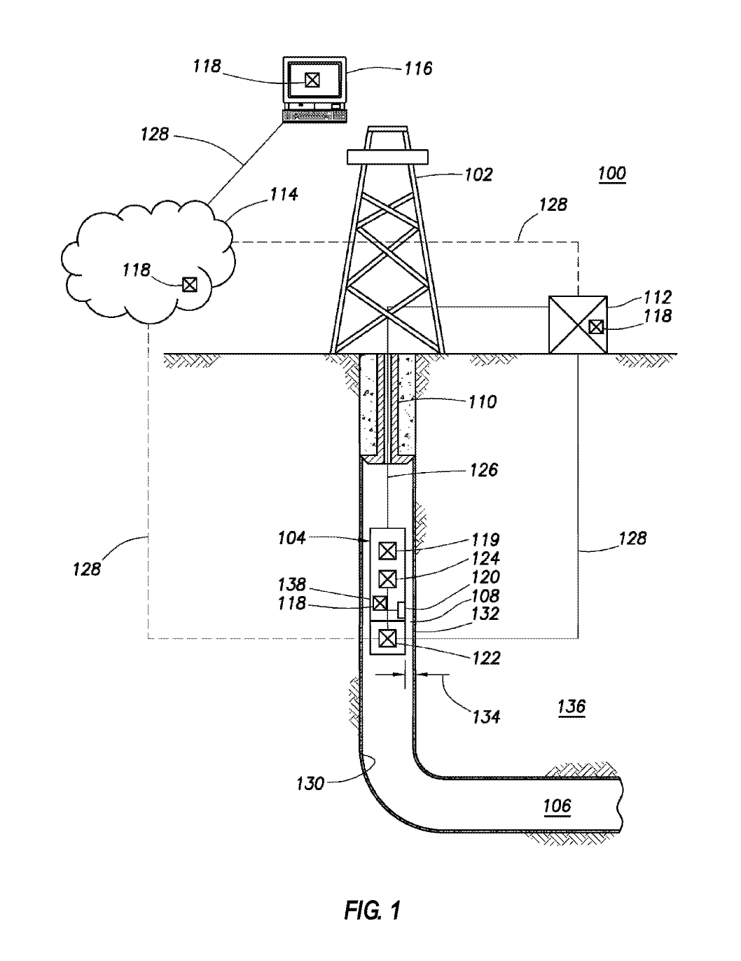

FIG. 1 is a schematic view of a wellsite 100 having an oil rig 102 with a downhole tool 104 suspended into a wellbore 106. The wellbore 106 has been drilled by a drilling tool (not shown). A drilling mud, and/or a wellbore fluid 108, may have been pumped into the wellbore 106 and may line a wall thereof. As shown, a casing 110 has also been positioned in the wellbore 106 and cemented into place therein. The downhole tool 104 may have one or more sensors for determining one or more downhole parameters, such as wellbore fluid parameters and/or formation parameters. The downhole tool 104 may communicate with a controller 112, a communication network 114 and/or one or more offsite computers 116. The downhole tool 104, the controller 112, the communication network 114 and/or the offsite computers 116 may have a formation imaging unit 118. The fluid parameters and/or the formation parameters sensed by the downhole tool 104 may be sent to the formation imaging unit 118 to determine formation properties and/or to optimize a well plan at the wellsite 100. The term “imaging” as used herein, is a common term in the geophysics and oilfield art to refer to a representation that depicts an array of localized properties of a wellbore in two or more dimensions.

The downhole tool 104 is shown as a wireline logging tool lowered into the wellbore 106 to take various measurements. The downhole tool 104 may include a conventional logging device 119, one or more sensors 120, one or more telemetry devices 122, and an electronics package 124. The conventional logging device 119 may be provided with various sensors, measurement devices, communication devices, sampling devices and/or other devices for performing wellbore operations. For example, as the downhole tool 104 is lowered, it may use devices, such as resistivity or other logging devices, to measure formation parameters and/or downhole fluid parameters. The formation parameters and/or the downhole fluid parameters may be the collected data regarding the formation and/or the downhole fluid. The formation imaging unit 118 may manipulate the formation parameters and optionally the downhole fluid parameters to determine formation properties and/or downhole fluid properties for example resistivity.

As shown, the downhole tool 104 may be conveyed into the wellbore 106 on a wireline 126. Although the downhole tool 104 is shown as being conveyed into the wellbore 106 on a wireline 126, it should be appreciated that any suitable conveyance may be used, such as a slick line, a coiled tubing, a drill string, a casing string and the like. The downhole tool 104 may be operatively connected to the controller 112 for communication between the tool 104 and the controller 112. The downhole tool 104 may be wired via the wireline 126, as shown, and/or wirelessly linked via the one or more telemetry devices 122. The one or more telemetry devices 122 may include any telemetry devices, such as electromagnetic devices, for passing signals to the controller 112 as indicated by communication links 128. Further, it should be appreciated that any communication device or system may be used to communicate between the downhole tool 104 and the controller 112. Signals may be passed between the downhole tool 104, the controller 112, the communication network 114, and/or the offsite computer(s) 116 and/or other locations for communication between these devices.

While the downhole tool 104 is depicted as the wireline tool having the one or more sensors 120 thereon, it will be appreciated that the one or more sensors 120 may be positioned downhole in a variety of arrangements and/or on a variety of one or more tools. For example, the one or more sensors 120 may be arranged in a pad suitable for being positioned across from the formation in the wellbore 106. The one or more sensors 120 (or a pad on which the sensors 120 are arranged) may also placed on any downhole system and/or tool for example, on a wireline logging tool, a drilling string, a logging while drilling tool (LWD), a measurement while drilling tool (MWD), a coiled tubing, a drill stem tester, a production tubing, a casing, a pipe, or any other suitable downhole tool. Although only one of the one or more sensors 120 is shown, it should be appreciated that one or more sensors 120 and/or portions of the one or more sensors 120 may be located at several locations in the wellbore 106. In some embodiments, the one or more sensors 120 may be positioned about an outer surface of the downhole tool 104 so that the wellbore fluid 108 may pass over or along the sensors 120. In some embodiments, the one or more sensors 120 may also be positioned at various locations about the wellsite 100 to perform fluid and/or formation measurements.

The electronics package 124 may include any components and/or devices suitable for operating, monitoring, powering, calculating, calibrating, and analyzing components of the downhole tool 104. Thus, the electronics package 124 may include a power source, a processor, a storage device, a signal conversion (digitizer, mixer, amplifier, etc.), a signal switching device (switch, multiplexer, etc.), a receiver device and/or a transmission device, and the like. The electronics package 124 may be operatively coupled to the one or more sensors 120 and/or the formation imaging unit 118. The power source may be supplied by the wireline 126. Further, the power source may be in the electronics package 124. The power source may apply multiple currents to the one or more sensors 120. The power source may be provided by a battery power supply or other conventional means of providing power. In some cases, the power source may be an existing power source used in the downhole tool 104. The power source may be positioned, for example, in the downhole tool 104 and wired to the one or more sensors 120 for providing power thereto as shown. Optionally, the power source may be provided for use with the one or more sensors 120 and/or other downhole devices. Although the electronics package 124 is shown as one separate unit from the one or more sensors 120 and/or the formation imaging unit 118, it should be appreciated that any portion of the electronics package 124 may be included within the one or more sensors 120 and/or the formation imaging unit 118. Further, the components of the electronics package 124 may be located at various locations about the downhole tool 104, the controller 112 and/or the wellsite 100. The one or more sensors 120 may also be wired or wirelessly connected to any of the features of the downhole tool 104, the formation imaging unit 118, the communication network 114, and/or the controller 112, such as communication links, processors, power sources or other features thereof.

The downhole fluid 108, or wellbore fluid, or borehole mud fluid, used at the wellsite 100 may be an oil-based mud. The downhole fluid 108 may be pumped into the wellbore 106 during drilling and/or other downhole operations. The downhole fluid 108 may coat a wellbore wall 130 as it encounters the wellbore wall 130. The downhole fluid 108 coated on the wellbore wall 130 may form a mud column 132, or mud standoff. The mud column 132 may refer to mud and/or borehole fluid between the one or more sensors 120 and the borehole wall and may occupy a gap 134, or standoff, or mud standoff, or sensor standoff, between the one or more sensors 120 and a subterranean formation 136. Further roughness of the wellbore wall 130 may cause the gap 134, or standoff, or sensor standoff, between the one or more sensors 120 and the subterranean formation 136. The oil-based mud may have a high resistivity. For example, the resistivity of a water-based mud may be between 0.01-20 Ohm and the resistivity for the oil-based mud may be 1,000 to 10,000,000 times higher than the water-based mud. Due to the high resistivity of the oil-based mud, the properties of the oil-based mud must be accounted for when determining formation properties, as will be discussed in more detail below. Because the same wellbore fluid 108, or mud, is typically used during wellsite operation, the properties of the downhole fluid 108 may remain relatively constant along the length of the wellbore 106.

The one or more sensors 120 may be capable of determining one or more downhole fluid parameters and/or one or more formation parameters. The one or more sensors 120 may determine the downhole parameters of the downhole fluids 108 and/or the subterranean formations 136 as the downhole tool 104 passes through the wellbore 106. As shown, the one or more sensors 120 may be positioned on an outer surface 138 of the downhole tool 104. A portion of the one or more sensors 120 may be recessed a distance below the outer surface 138 to provide additional protection thereto, or protruded a distance therefrom to access fluid and/or subterranean formation 136. The one or more sensors 120 may also be positioned at various angles and locations as desired.

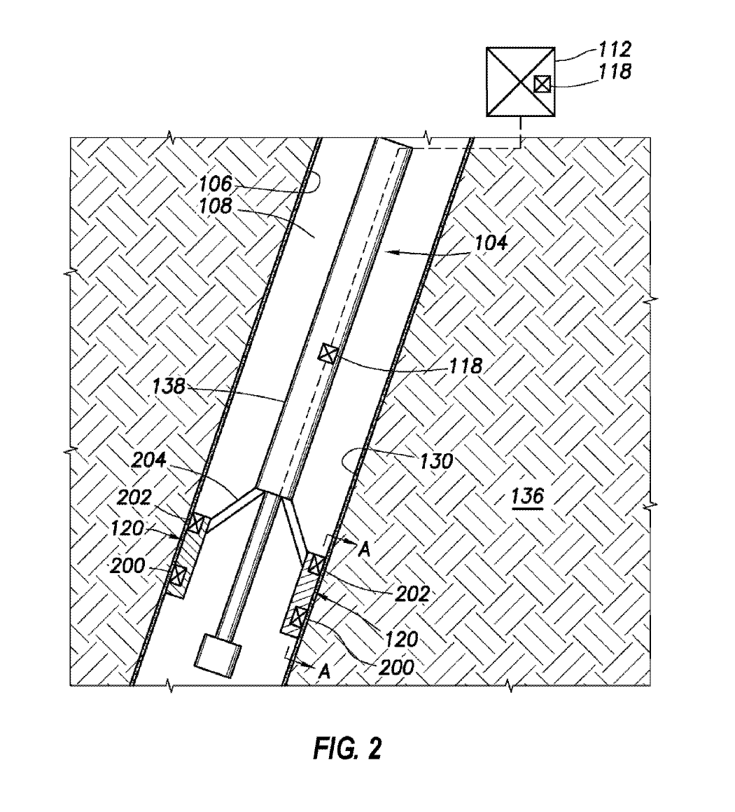

FIG. 2 shows a schematic view of the downhole tool 104 located in the wellbore 106 and within the subterranean formation 136. As depicted, the downhole tool 104 is a wireline microresistivity tool containing the one or more sensors 120 with a formation sensor 200 and optionally a mud sensor 202. The one or more sensors 120 may be located on the outer surface 138, or located on one or more arms 204 which extend from downhole tool 104. The one or more arms 204 may be configured to place the one or more sensors 120 as close to the wellbore wall 130, or against the mud column 132 on the wellbore wall 130, as possible. The one or more arms 204 may be actuatable, or spring loaded in order to locate the one or more sensors 120 against the wellbore wall 130.

The formation sensor 200 may be any sensor configured to determine one or more formation parameters. The formation sensor 200 may send, or inject, a plurality of currents through a portion of the subterranean formation 136 between two electrodes. The plurality of currents may have two or more frequencies, as will be discussed in more detail below. The plurality of currents may pass through the downhole fluid 108 and the subterranean formation 136. The injected current may include information regarding formation and/or fluid parameters. The current detected by the formation sensor 200 may be sent to the formation imaging unit 118. The formation and/or fluid parameters may be manipulated by the formation imaging unit 118 to determine one or more formation properties, as will be discussed in more detail below. When the downhole fluid 108 is the oil-based drilling mud, the impedance contribution from the mud column 132 may be significantly larger than the impedance contribution from the formation 136.

The mud sensor 202 may be an optional sensor configured to determine one or more downhole fluid parameters. The mud sensor 202 may be configured to send, or inject, current through the downhole fluid 108 and/or the mud column 132. The current injected and detected by the mud sensor 202 may have the same frequencies as the plurality of currents injected by the formation sensor 200. The current detected by the mud sensor 202 may be sent to the formation imaging unit 118.

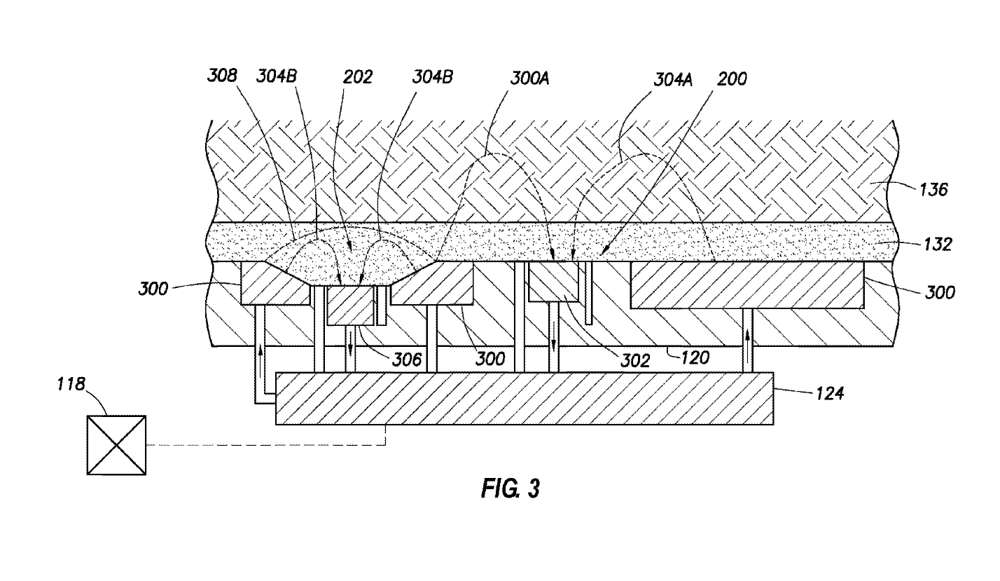

FIG. 3 depicts a cross sectional view of the sensor pad 120 of FIG. 2 having the formation sensor 200 and the mud sensor 202. As shown, the formation sensor 200 may have one or more source electrodes 300 and one or more return electrode 302 connected to the electronics package 124. The electronics package 124 may send a plurality of currents 304A to the source electrode 300. The plurality of currents 304A may travel through the mud column 132, through the subterranean formation 136 and into the return electrode 302. The return electrode 302 may send the collected plurality of currents 304A to the electronics package 124 and/or the formation imaging unit 118.

The sensor pad 120 may optionally have the mud sensor 202. The mud sensor 202 may be configured to send a plurality of currents 304B through the mud column 132 and/or the downhole fluid 108 (as shown in FIG. 1). By sending the plurality of currents 304B through the mud column 132 and/or downhole fluid 108 only, the downhole fluid parameters may be determined The mud sensor 202 may have the one or more source electrodes 300 and a mud return electrode 306. The electronics package 124 may send the plurality of currents 304B to the mud sensor 202, and source electrodes 300. The mud sensor 202, as shown, has a recessed configuration. The recessed configuration may be configured to pass the plurality of currents 304B through a fluid zone 308. The mud return electrode 306 may send the collected plurality of currents 304B to the electronics package 124 and/or the formation imaging unit 118.

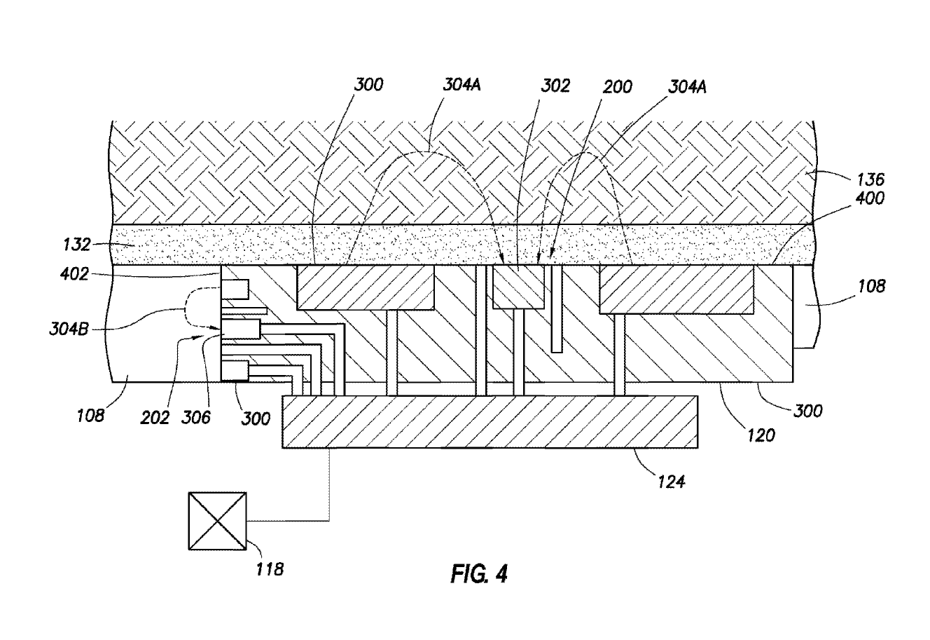

FIG. 4 depicts a cross sectional view of an alternated sensor pad 120 of FIG. 2 having the formation sensor 200 and the mud sensor 202. The formation sensor 200, as shown, may be located proximate a face 400 of the pad in a similar manner as shown in FIG. 3. In some embodiments, the mud sensor 202 may be located on a side surface 402 of the sensor pad 120. Locating the mud sensor 202 on the side surface 402 may allow the plurality of currents 304B sent from the source electrodes 300 to the mud return electrode 306 to pass only through the downhole fluid 108. In a similar manner, as described herein, the return electrode 302 and the mud return electrode 306 may send the collected plurality of currents 304A and/or 304B to the electronics package 124 and/or the formation imaging unit 118. Although the mud sensor 202 is shown as being a recessed sensor, or a sensor on the side surface 402 of the sensor pad 120, it should be appreciated that the mud sensor 202 may be any suitable sensor for determining the downhole fluid parameters. The mud sensor 202 may also pass the plurality of current 304B through the formation 136. Further, the formation sensor 200 may be any suitable sensor for determining formation and/or downhole fluid parameters.

The plurality of currents 304A and/or 304B may be high frequency current in order to penetrate the highly resistive oil-based mud. Due to the high frequency of the plurality of currents 304A and/or 304B, the source electrodes 300 and the return electrode 302 and/or the mud return electrode 306 may be located in close proximity to one another, as shown in FIGS. 3 and 4. The frequency range of the formation sensor 200 and/or the mud sensor 202 may be optimized in a frequency range from a few hundred KHz up to roughly 100 Mhz. Due to the frequency, the formation sensor 200 and/or the mud sensor 202 may be adapted to the full range of oil-based-mud micro-resistivity imaging tools such as OBMI, as shown in U.S. Pat. No. 6,191,588, which is herein incorporated by reference in its entirety. Thus, the downhole tool 104 (as shown in FIG. 1) may measure the downhole fluid 108 at the same, or similar, frequency or frequencies as the subterranean formation 136.

The source electrodes 300, the return electrodes 302, and the mud return electrode 306 may be any conventional electrode capable of generating the plurality of currents 304A and/or 304B across the oil-based mud, or downhole fluid 108. A power source (e.g., included in the electronics package 124 of FIG. 1) may be operatively connected to the source and return electrodes 300/302 for applying a voltage (V+, V−) thereacross. As voltage is applied, a plurality of currents 304A/304B that may flow out of one of the electrodes 300/302, for example the source electrodes 300 that can be measured by the return electrodes 302 and/or the mud return electrode 306. The source electrodes 300 and the sensor electrodes may be geometrically and materially optimized to match substantially to a fixed characteristic impedance transmission line.

The current from the electrodes may be used to determine various parameters. In an example involving a fluid passing between a pair of electrodes, an AC voltage V is applied between two electrodes to generate a resultant current I that can be measured at the sensor electrode, for example the return electrode 302 or the mud return electrode 306. The complex impedance Z may be determined from the measured current I based on the following:

z=|z|exp(iφ_{z}) Equation (1)

where its magnitude |z| based on Ohms law and phase φ_{z} are defined as follows:

|z|=|V/I| Equation (2)

φ_{z}=phase of I relative V Equation (3)

and where exp (iφ_{z}) based on Euler's formula is defined as follows:

exp(iφ_{z})=cos φ_{z}+isin φ_{z} Equation (4)

The magnitude and phase of the impedivity (sometimes referred to as the complex impedivity) of a fluid ζ is defined as follows:

ζ=|ζ|exp(iφ_{ζ}) Equation (5)

Equation (5) may be derived from z when the fluid is measured by the mud sensor 202 by the relations as follows:

|ζ|=k|z| Equation (6)

Equation (6) may also be written as follows:

|ζ|=k|V|/|I| Equation (7)

The phase (or dielectric angle) of the fluid ζ is derived as follows:

φ_{ζ}=φ_{z} Equation (8)

where:

|ζ| is the magnitude of impedivity,

φ_{ζ} is the phase angle of the impedivity, and

k is a constant for the device.

The constant k may be measured empirically, for example, by measuring the impedance V/I between electrodes as a fluid of known impedivity. The constant k may also be calculated from the geometry of the electrodes using conventional methods.

Data concerning the measured current may be used to determine fluid parameters, such as impedivity, resistivity, impedance, conductivity, complex conductivity, complex permittivity, tangent delta, and combinations thereof, as well as other parameters of the downhole fluid 108. The data may be analyzed to determine characteristics, or properties, of the wellbore fluid 108, such as the type of fluid (e.g., hydrocarbon, mud, contaminants, etc.) The formation imaging unit 118 may be used to analyze the data, as will be discussed in more detail below. Such analysis may be performed with other inputs, such as historical or measured data about this or other wellsites. Reports and/or other outputs may be generated from the data. The data may be used to make decisions and/or adjust operations at the wellsite. In some cases, the data may be fed back to the wellsite 100 for real-time decision making and/or operation.

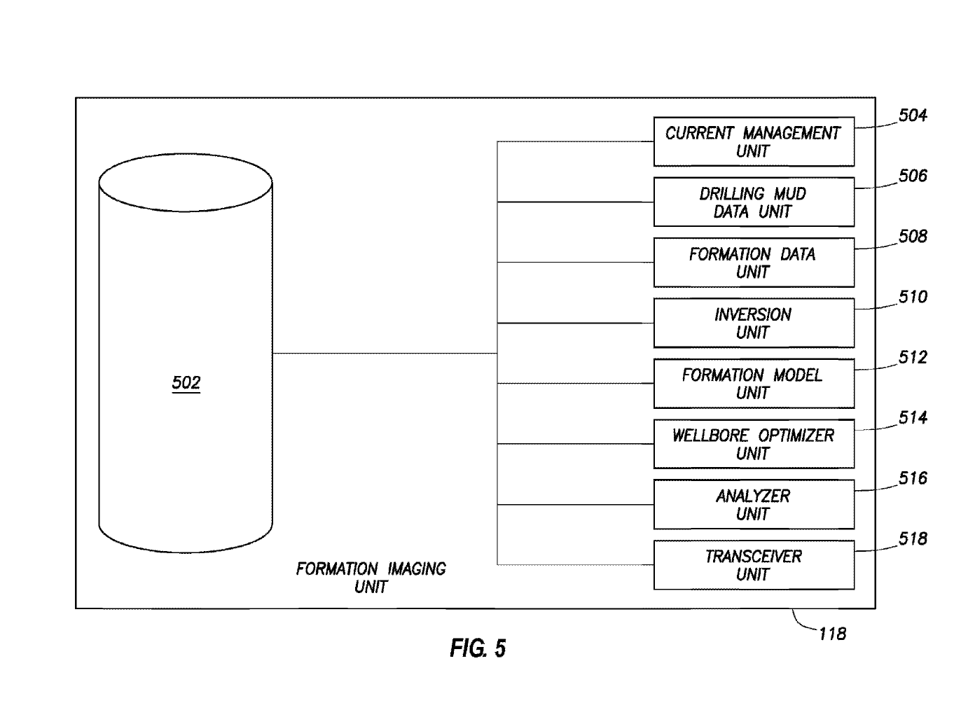

FIG. 5 depicts a block diagram illustrating the formation imaging unit 118 of FIG. 1. The formation imaging unit 118 may be incorporated into or about the wellsite 100 (on or off site) for operation with the controller 112. The formation imaging unit 118 may determine, generate, and/or model various formation properties. For example, in some embodiments, the formation imaging unit 118 may use an inversion for borehole imaging with a multi-frequency approach. The formation imaging unit 118 may invert for the formation resistivity, the formation permittivity, and optionally the mud standoff to determine formation properties. The formation properties may be used to produce a formation model. Moreover, in some embodiments, the formation imaging unit 118 may be used to compare the inverted resistivity unit with the inverted standoff image, the inverted permittivity image, or both, to indicate an accuracy of the borehole imaging. For example, the formation imaging unit may output a composite image representative of the borehole formation. The comparison of the inverted images (e.g., inverted resistivity image with the inverted standoff image and/or inverted permittivity image) may provide a quality indicator for the quality and/or accuracy of the composite image.

The formation imaging unit 118 may take the form of an entirely hardware embodiment, an entirely software embodiment (including firmware, resident software, micro-code, etc.), or an embodiment combining software and hardware aspects. Embodiments may take the form of a computer program embodied in any medium having computer usable program code embodied in the medium. The embodiments may be provided as a computer program product, or software, that may include a machine-readable medium having stored thereon instructions, which may be used to program a computer system (or other electronic device(s)) to perform a process. A machine readable medium includes any mechanism for storing or transmitting information in a form (such as, software, processing application) readable by a machine (such as a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. Embodiments may further be embodied in an electrical, optical, acoustical or other form of propagated signal (e.g., carrier waves, infrared signals, digital signals, etc.), or wireline, wireless, or other communications medium. Further, it should be appreciated that the embodiments may take the form of hand calculations, and/or operator comparisons. To this end, the operator and/or engineer(s) may receive, manipulate, catalog and store the data from the downhole tool 104 in order to perform tasks depicted in the formation imaging unit 118.

The formation imaging unit 118 may include a storage device 502, a current management unit 504, a mud data unit 506, a formation data unit 508, an inversion unit 510, a formation model unit 512, a wellbore optimizer unit 514, an analyzer unit 516, and a transceiver unit 518. The storage device 502 may be any conventional database or other storage device capable of storing data associated with the wellsite 100, shown in FIG. 1. Such data may include, for example current frequencies, current time and/or location sent, downhole fluid parameters, formation parameters, downhole fluid properties, formation properties, historical data, formation models, and the like. The analyzer unit 516 may be any conventional device, or system, for performing calculations, derivations, predictions, analysis, and interpolation, such as those described herein. The transceiver unit 518 may be any conventional communication device capable of passing signals (e.g., power, communication) to and from the formation imaging unit 118. The current management unit 504, a mud data unit 506, a formation data unit 508, an inversion unit 510, a formation model unit 512, and a wellbore optimizer unit 514 may be used to receive, collect and catalog data and/or to generate outputs as will be described further below. Portions or the entire formation imaging unit 118 may be located about the wellsite 100 (as shown in FIG. 1).

The current management unit 504 may be configured to generate and collect the appropriate number and frequency of the plurality of currents 304A and/or 304B, depending on the wellbore 106 conditions and/or the type of sensor pad 120 used. The number of frequencies used may depend on the number of formation parameters and/or downhole fluid parameters to be calculated using the inversion unit 510. The number of currents and frequencies used may be dependent on the downhole fluid 108 (as shown in FIG. 1) being measured in-situ, or alternatively calculated using an inversion. In some embodiments, logging data may be inverted to provide inverted borehole images, including, for example, inverted resistivity images, inverted standoff images, and inverted permittivity images.

If the sensor 120, downhole tool 104 and/or a separate downhole tool (not shown) have the mud sensor 202 (as shown in FIGS. 2-4) then the number of the plurality of currents 304A sent into the formation may be minimized at two logging frequencies. If the mud sensor 202 is not present, the mud properties will be inverted for and will require the current management unit 504 to generate the plurality of currents 304A at a minimum of three logging frequencies. The number of logging frequencies used may increase to improve accuracy and/or as the number of unknowns in the downhole fluid and/or the formation increase, as will be described in more detail below.

The current management unit 504 may send the determined number of multiple logging frequencies into the formation at substantially the same time at multiple locations along the formation. The plurality of currents 304B for measuring the downhole fluid properties may have the same logging frequencies, or a portion of the logging frequencies, as those sent into the subterranean formation 136 (as shown in FIG. 1). The current management unit 504 may collect, catalog, store and/or manipulate current data regarding the logging frequencies sent and collected by the formation sensor 200 and/or the mud sensor 202 (as shown in FIG. 2). A historical record of the current data may be kept for each logging location in the wellbore 106 (as shown in FIG. 1).

The mud data unit 506 may be used to collect, catalog, store, manipulate and/or supply mud data. The mud data may be the measured data from the mud sensor 202 (as shown in FIG. 2). In some embodiments, the mud data may be obtained from the measured data from the formation sensor 200, when there is no separate mud sensor 202. If there is no separate mud sensor 202, the mud data may be inverted along with formation data to determine the downhole fluid properties, as will be discussed in more detail below. The measured mud data may be measured mud parameters, or mud electric parameters, that may be manipulated by the inversion unit 510 to determine mud and/or formation properties. The mud data, or mud parameters, may be mud impedance, permittivity, resistivity, loss tangent or other derived parameter and mud standoff. This mud data that is measured may be manipulated to determine mud properties such as mud permittivity, current amplitude, current phase, resistivity and conductivity. The downhole fluid properties typically do not change significantly in the wellbore 106. Therefore, it may only be necessary to measure or invert for the mud parameters periodically at a much lower sampling rate than obtaining the formation parameters. The borehole fluid parameters, or properties, may be determined by the one or more sensors independent of a determination of the formation parameters. Thus, the determined fluid parameters may be used to more accurately determine the formation parameters as will be described in more detail below.

The formation data unit 508 may be used to collect, catalog, store, manipulate and/or supply formation data. In some embodiments, the formation data may be the measured data from the formation sensor 200 (as shown in FIG. 2). Because the plurality of currents 304A (as shown in FIGS. 3 and 4) may have data regarding the mud and the formation, the formation data may have to be manipulated in order to determine the formation parameters and/or formation properties. The formation data, or formation parameters, may be the measured parameters from the formation 136 such as formation impedance, amplitude and phase of the current, and the like. The formation data, or formation parameters, may be manipulated along with the mud data to determine formation properties such as resistivity, conductivity, permittivity, and the like. The formation data may be obtained from the plurality of currents 304A (as shown in FIGS. 3 and 4) at the plurality of frequencies. The formation data may have current data from a plurality of locations along the wellbore 106.

The inversion unit 510 may obtain the formation data and mud data from the mud data unit 506 and/or the formation data unit 508. To determine formation resistivity, or an inverted formation resistivity, the inversion unit 510 may invert, or parametrically invert, the multiple current measurements made at several frequencies, as will be described in more detail below. The number of frequencies used may depend on the number of parameters to be inverted. The inversion unit 510 may invert the mud data and/or the formation data in order to determine formation properties and/or downhole fluid properties. The inverted formation data, and optionally, the mud data, obtained at the plurality of frequencies may be used to obtain formation properties for borehole imaging. The parameters to be inverted may be the formation resistivity, the formation permittivity, and/or the mud standoff (if the mud data is collected independently of the formation data). If the mud parameters are not measured, for example, by the mud sensor 202 (as shown in FIG. 2), the downhole fluid properties may be inverted for by adding extra frequencies to the plurality of current 304A used by the formation sensor 200. The inversion unit 510 may further invert signal biases caused by systematic measurement drifts in the in-phase and out-of-phase signals or in the phase and amplitude signals.

The plurality of currents 304A (as shown in FIGS. 3 and 4) may first pass through the mud column 132, or mud-standoff, then the formation. The impedance from the mud column 132 and the formation combined may be measured. The measured impedance may be given approximately as:

$$Z = V \text{/} I = {K}_{mud} Δ \frac{{R}_{mud}}{1 + j {ωɛ}_{0} {ɛ}_{mud} {R}_{mud}} + {K}_{rock} \frac{{R}_{rock}}{1 + j {ωɛ}_{0} {ɛ}_{rock} {R}_{rock}} \qquad ( Equation 9 )$$

Where Δ is the mud standoff, K_{mud} and K_{rock} are tool related coefficients, and ω is the operating frequency, or logging frequency for each of the plurality of currents 304A. ε_{mud} and ε_{rock} may be the relative permittivity of the mud and the formation respectively. R_{mud} and R_{rock} may be the resistivity of the mud and the formation respectively. The term ε₀ represents the dielectric permittivity of free space (a constant=8.85419×10⁻¹²) and j represents \sqrt{−1}. The terms subscripted by “mud” represent the contribution to Z from the mud occupying the space between the face of the electrodes and the formation, depending of the electrical properties of the formation, the properties ε_{rock} and R_{rock} the contribution from the mud or mud column 132 may be significantly larger than the contribution from the formation.

In equation 9, the formation sensor 200 (as shown in FIGS. 2-4) current I may have independent components that are respectively in-phase and out-of-phase with the voltage V. These may be its real and imaginary parts real(I) and imag(I). Therefore, equation 9 may represent two independent equations:

real(V/I)=ΔK_{mud}R_{mud}/[1+(ωεₒε_{mud}R_{mud})²]+K_{rock}R_{rock}/[1+(ωεₒε_{rock}R_{rock})²] (Equation 10)

imag(V/I)=−ωεₒ{ΔK_{mud}ε_{mud}R_{mud}²/[1+(ωεₒε_{mud}R_{mud})²]+K_{rock}ε_{rock}R_{rock}¹/[1+(ωεₒε_{rock}R_{rock})²]} (Equation 11)

There may be five unknowns in these two equations R_{rock}, ε_{rock}, R_{mud}, ε_{mud}, and Δ. R_{rock} may be the property of interest that is used to create a formation model. Therefore, if three of these unknowns may be accounted for then R_{rock} may be calculated.

The measured impedance Z, the formation resistivity R_{rock} and the mud standoff Δ may be frequency independent parameters. Therefore, these frequency independent parameters may correspond to two unknown parameters that are fixed at a particular logging point irrespective of the number of frequencies used. The formation permittivity ε_{rock} may also be an unknown parameter. The unknown formation permittivity ε_{rock} may be included in the inversion. The formation permittivity ε_{rock} may be frequency dependent. Thus, the number of formation permittivities ε_{rock} to be inverted may be equal to the number of operating frequencies, or logging frequencies used. Alternatively, the inversion unit 510 may model the formation permittivity ε_{rock} as a polynomial function of frequency or in terms of any other functional form. In some embodiments, a minimum number of coefficients may be used to describe the frequency dependence. The inversion unit 510 may then invert for the coefficients instead of the formation permittivity ε_{rock}. One example of an inversion may be given as follows:

ε_{rock}=a₁+a₂ωⁿ¹R_{rock}ⁿ² (Equation 12)

where a₁, a₂, n₁, n₂ may be unknown coeffiecients which may be found by performing an inversion with the inversion unit 510. The number of coefficients may be fixed and therefore does not change with the number of logging frequencies used. Therefore, the number of unknowns due to the formation permittivity ε_{rock} may not increase with the number of frequencies if the coefficients are determined by inversion. Alternatively, in some embodiments, R_{rock}, ε_{rock} , or both, may be frequency dependent. The coefficients introduced to represent the frequency dependence can be inverted for by increasing the number of logging frequencies to make available a sufficiently large number of equations.

The downhole fluid properties, or mud properties, such as permittivity and conductivity, may also be frequency dependent, or function of the frequencies. The mud properties may be directly inverted for at each logging frequency. In some embodiments, the mud properties may also be expressed as a polynomial function of frequency or in any other functional form with a minimum number of coefficients. These coefficients may be determined by inversion using the inversion unit 510.

In some embodiments, to determine the unknown parameters, or formation and/or downhole fluid properties R_{rock}, ε_{rock}, R_{mud}, ε_{mud}, and Δ, the inversion unit 510 may perform an inversion of the formation data and/or the mud data. The inversion may be an iterative process where estimates or guesses for the unknown properties R_{rock},ε_{rock}, R_{mud}, ε_{mud}, and Δ are successively refined to reduce to a minimum the difference between the measured current values and corresponding values computed from a forward model, using as input the guessed values of the unknown parameters. In one example, equation 9 is the forward model. The functions K_{mud} and K_{rock} may be specific to a particular downhole tool 104 (as shown in FIG. 1). To make inversion feasible, a forward model such as equation 9 may be constructed that represents closely the behavior of the actual downhole tool. Any suitable method of representing the behavior of the downhole tool 104 may be used. For example, a finite element (FE) modeling may be used to compute the formation sensor current, and/or the mud sensor current, for a particular downhole tool 104. The FE model may take into account the geometry and frequency of the downhole tool, and the materials used in its construction. It may also take into account the position of the downhole tool relative to the wellbore wall 130 and/or the mud column 132, the size of the wellbore 106 and the materials inside and surrounding it. A large number of such FE simulations may be made to populate a representative volume of (R_{rock}, ε_{rock}, R_{mud}, ε_{mud}, and Δ) space, for the logging frequencies concerned. These numerical data may then be used to construct an analytic form, such as equation 9 with the analytic functions K_{mud} and K_{rock}. Using this inversion process, the formation resistivity R_{rock}, or inverted formation resistivity, may be determined.

The downhole tool 104 electronics may be difficult to calibrate at a high operating frequency. Therefore impedance measurements might have a systematic drift in the in-phase or out-of-phase components. The systematic drifts may be part of the unknowns to be inverted by the inversion unit 510.

If the mud parameters are not directly measured, for example by the mud sensor 202 (as shown in FIGS. 2-4), the downhole fluid properties may be inverted for with the formation properties and/or the mud standoff. In order to invert for the downhole fluid properties the number of frequencies used in the plurality of currents 304A may be increased. The increase in number of frequencies may allow the inversion unit to determine the additional unknowns created by the borehole fluid parameters being unknown. The borehole fluid properties 108 (as shown in FIG. 1) remains fairly constant in the wellbore. Therefore, the inversion unit 510 may only invert for the borehole fluid properties sporadically. Therefore, the increased number of frequencies and therefore, the number of the plurality of currents 304A may only need to be increased sporadically while processing the logging data. Further, the number of currents 304A used may be increased to allow the inversion unit to determine the mud properties during the entire logging operation. In some embodiments, the logging data may also be processed and/or inverted after the logging operation.

The formation model unit 512 may construct a formation model from the formation properties obtained by the inversion unit 510. The formation model may be any suitable model for determining formation properties and/or the location of valuable downhole fluids such as hydrocarbons. The formation model may be constructed based on the formation resistivity R_{rock}. The formation model unit 512 may store, manipulate, and organize one or more formation models. The formation model may be an approximate model, or may be replaced by a tool model derived using 3D modeling. The 3D model may be constructed using the data from the inversion unit 510, for example the multi-frequency parametric inversion, to obtain the formation resistivity from the measured impedance.

The formation model may be constructed with one or more layer boundaries using inverted formation properties from measurements taken at multiple logging points in the wellbore 106 (as shown in FIG. 1). Thus, the formation model may be a homogeneous formation model at each logging point in order to limit the number of model parameters. The homogeneous approach may lead to uncertainty at or near the formation boundaries where the medium is not homogeneous. Therefore, a multi-layer formation model may be constructed by the formation model unit 512 to represent the formation. For the multi-layered formation model more parameters may be inverted by the inversion unit 510. For example, each formation layer may have its resistivity, permittivity, boundary positions, layer dip, and/or layer azimuth inverted. The increased number of parameters to be inverted by the inversion unit 510 may require using measurements of multiple log points in the inversion.

Furthermore, in some embodiments, the inversion unit 510 may invert at multiple log points. Such a multipoint inversion strategy may assume that mud properties change relatively slowly and are relatively constant locally in a bore hole, while each individual log point has unique formation properties and standoff. Mud properties, as well as other less sensitive model parameters, may be approximated and/or estimated and applied over multiple log points.

Some embodiments may also account for the change of mud properties along depths of the borehole. A multistep inversion technique may involving periodically inverting mud properties after initial segmentation. In one embodiment, the mud properties may be inverted for a relatively short interval (e.g., approximately less than 10 ft long). The mud properties may then be used to invert the sensor standoff and formation properties for longer log sections (e.g., approximately 200 ft or longer). The inversion may be run in multiple passes, iteratively refining the mud properties. In some embodiments, multiple inversions may be run for the same inversion outputs, and the accuracy of inversion outputs may be determined based on a comparison of the outputs from the multiple inversions.

Mud properties may also compensate for imperfect measurement calibration. In some embodiments, different mud properties may be assumed for each button. An inversion of multiple buttons may be conducted simultaneously, using common mud properties for a pad or group of pads. The calibration amplitude and phase may be solved. After mud properties are calibrated, a more accurate mud angle may be used in a suitable processing scheme. In some embodiments, the mud angle variation may also be taken into account based on changes observed in conventional mud angle logs.

The inversion unit 510 may also be used for inversion workflows which increase the efficiency of the inversion process. For example, in one embodiment, periodic inversions may be conducted after an initial segmentation. The inversion unit 510 may perform inversion on relatively smaller portions of the wellbore to reconstruct mud data from the formation. The mud data may be interpolated between these smaller portions of the wellbore to make assumptions on a larger zone of the wellbore. A full inversion may be conducted at a later time.

In some embodiments, the inverted resistivity images, inverted standoff images, and inverted permittivity images may be used alone or in combination to indicate various features of the wellbore 106 or the formation 136. For example, the standoff image may be an indicator of the borehole rugosity and fractures and may also be used to evaluate the geo-mechanics, stability, rock strength (e.g., fracture-ability) of the wellbore 106, as well as other borehole surface events, such as drilling-activated fault slips or side-wall coring positions. The inverted images may also be used in combination to provide further information. For example, the inverted standoff image may be compared with the inverted resistivity image to indicate the quality of the composite image, to diagnose imaging problems, to evaluate fractures and whether they are open or closed, and/or to indicate breakouts. In some embodiments, the inverted permittivity image may be compared with the inverted resistivity image or other suitable measurements to evaluate the fluid types of reservoir rocks.

The wellbore optimizer unit 514 may use the formation model and/or any of the data stored in the formation imaging unit 118 to construct, optimize, change and/or create a well plan. The well plan may allow an operator, controller and/or driller to optimize the production of hydrocarbons from the wellsite. For example, the well plan may determine drilling trajectories, location of multiple wellbores, drilling methods, completion methods, production methods, and the like. The wellbore optimizer unit 514 may be an optional unit. Further, the wellbore optimizer unit 514 may be located offsite.

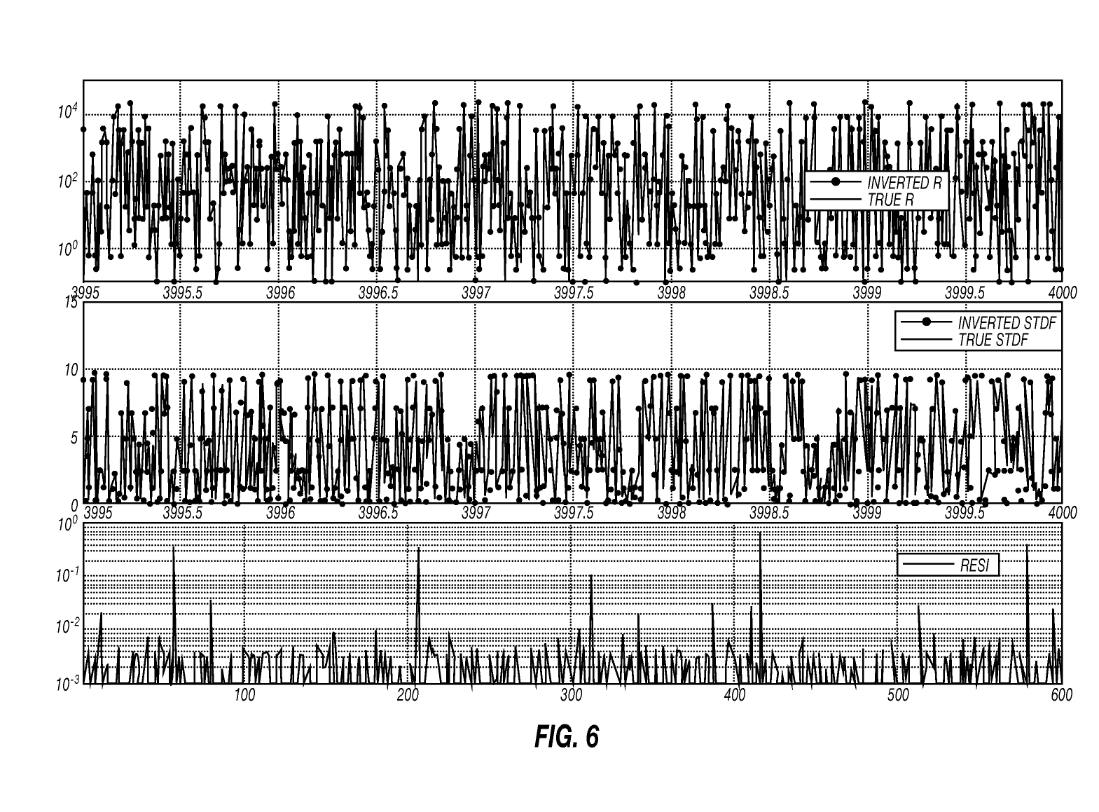

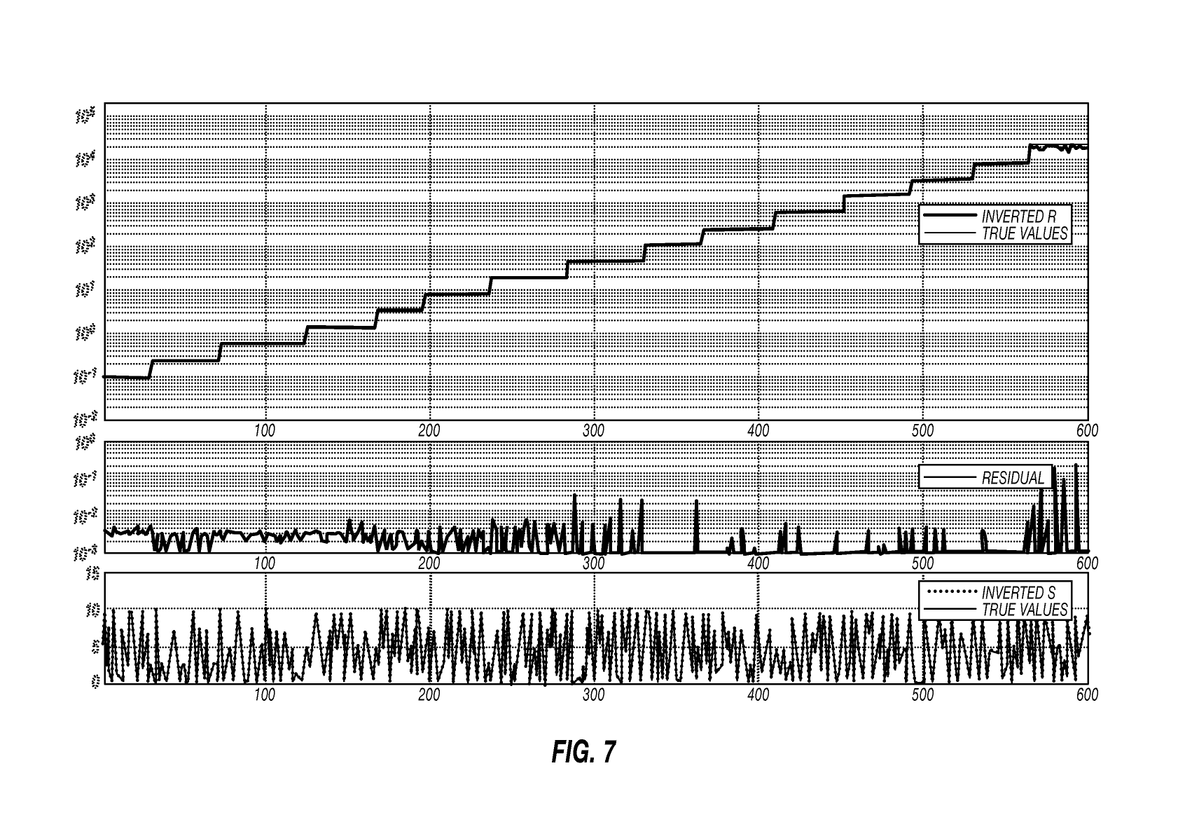

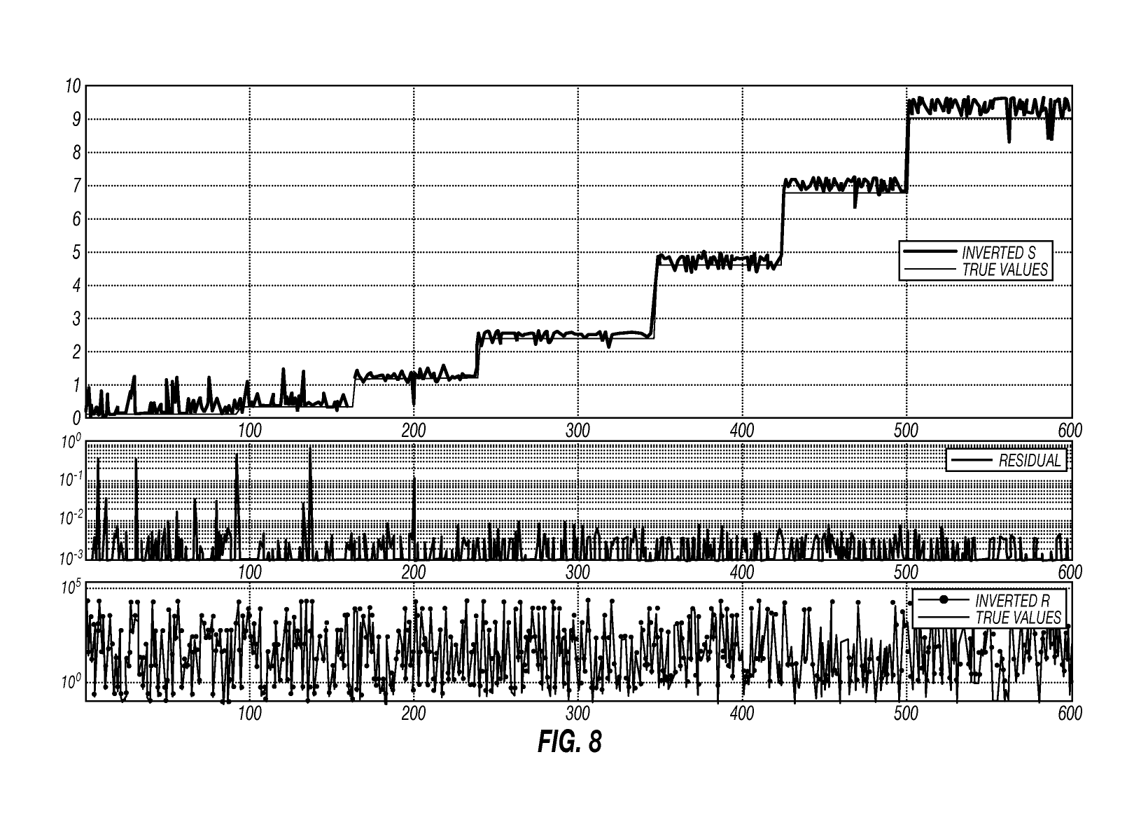

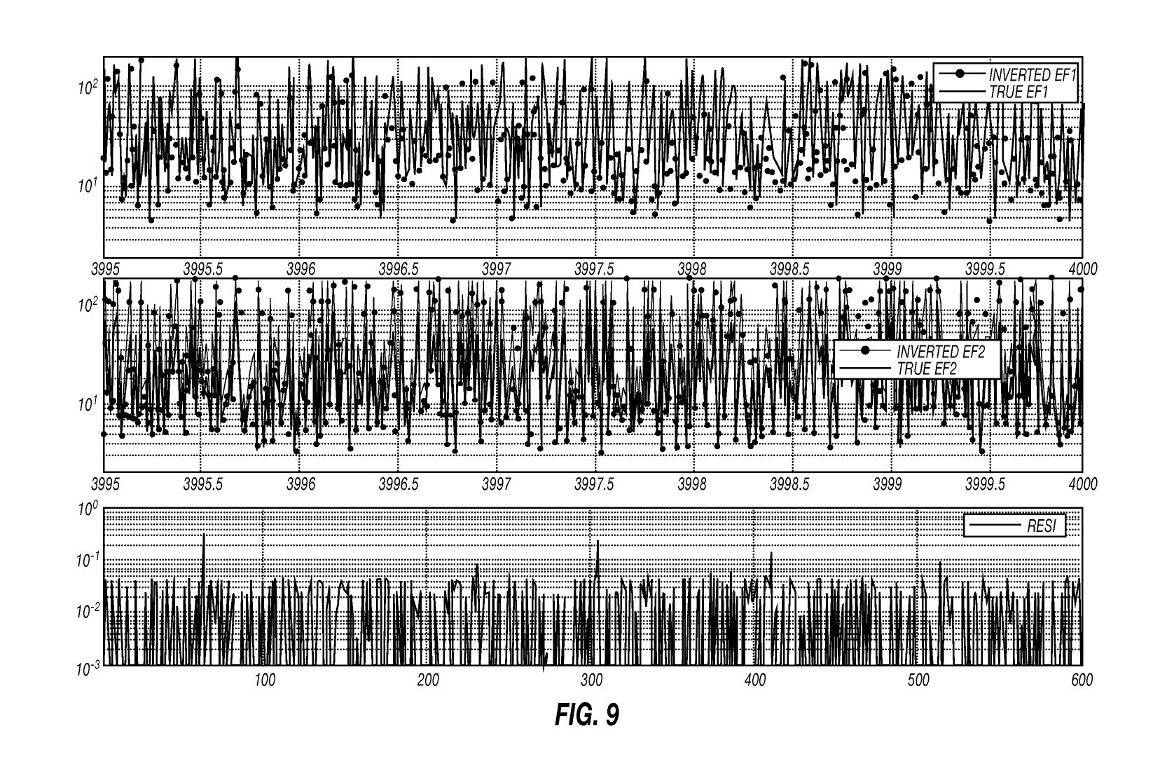

FIGS. 6-9 are graphical depictions of various outputs that may be generated by the formation imaging unit of FIG. 5. FIG. 6 depicts an example of formation resistivity-standoff profile and inverted values with modeled mud properties at ε_{M1}=10, ε_{M2}=10, φ_{M1}=−81°, and φ_{M2}=−81°. The plot of FIG. 6 may represent a mud evaluation interval, and inverted values of mud properties are ε_{M1}=10.41, ε_{M2}=10.49, φ_{M1}=−81.12°, φ_{M2}=−80.38°, converging in four steps. Points where the residual was above 10% may correspond to maximal formation resistivity of 20,000 Ωm, where sensitivity is relatively low. The same results are presented in FIG. 7, with the resistivity reordered from low to high to demonstrate how reconstruction of resistivities may be consistent. Similarly, to evaluate the quality of inverted standoff, the plot in FIG. 8 has a staircase standoff profile. High values of residual are for highest resistivites and low standoff (below 0.5 mm). Reconstructed standoff matches well the true values, typically within 1 mm. Inverted formation permittivities at two frequencies are shown in FIG. 9. The high frequency permittivity is better resolved, since measurements are more sensitive to it, especially for higher resistivities.

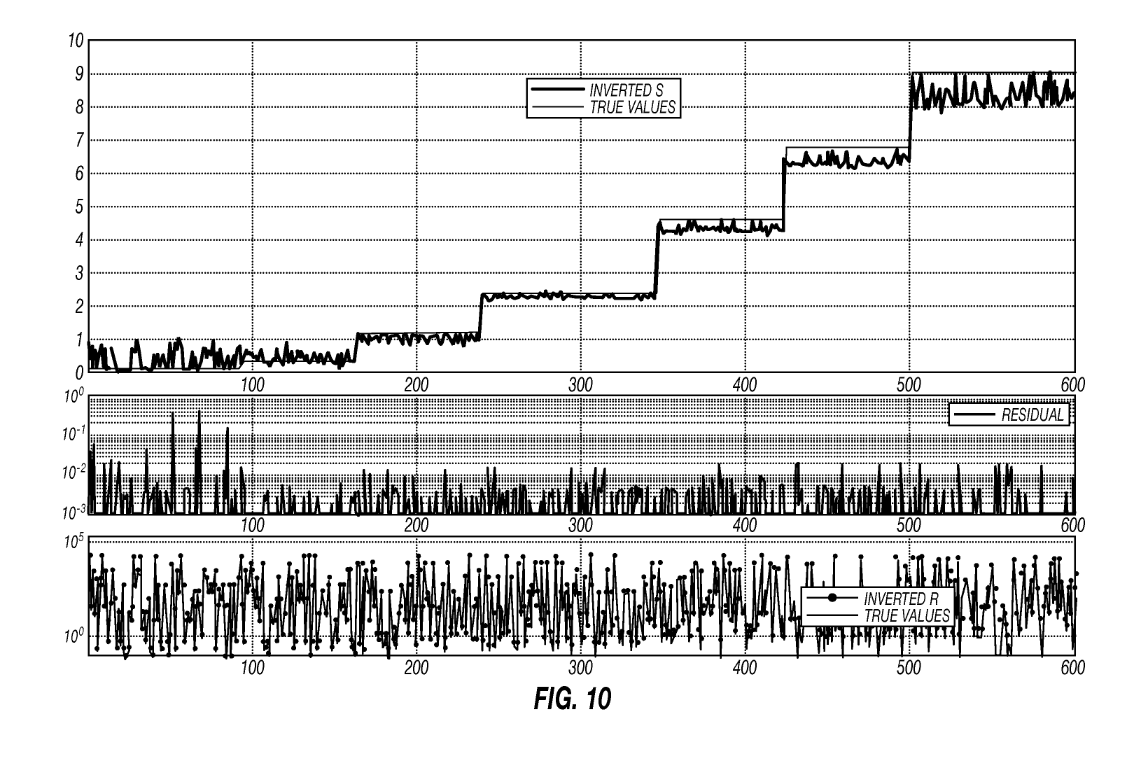

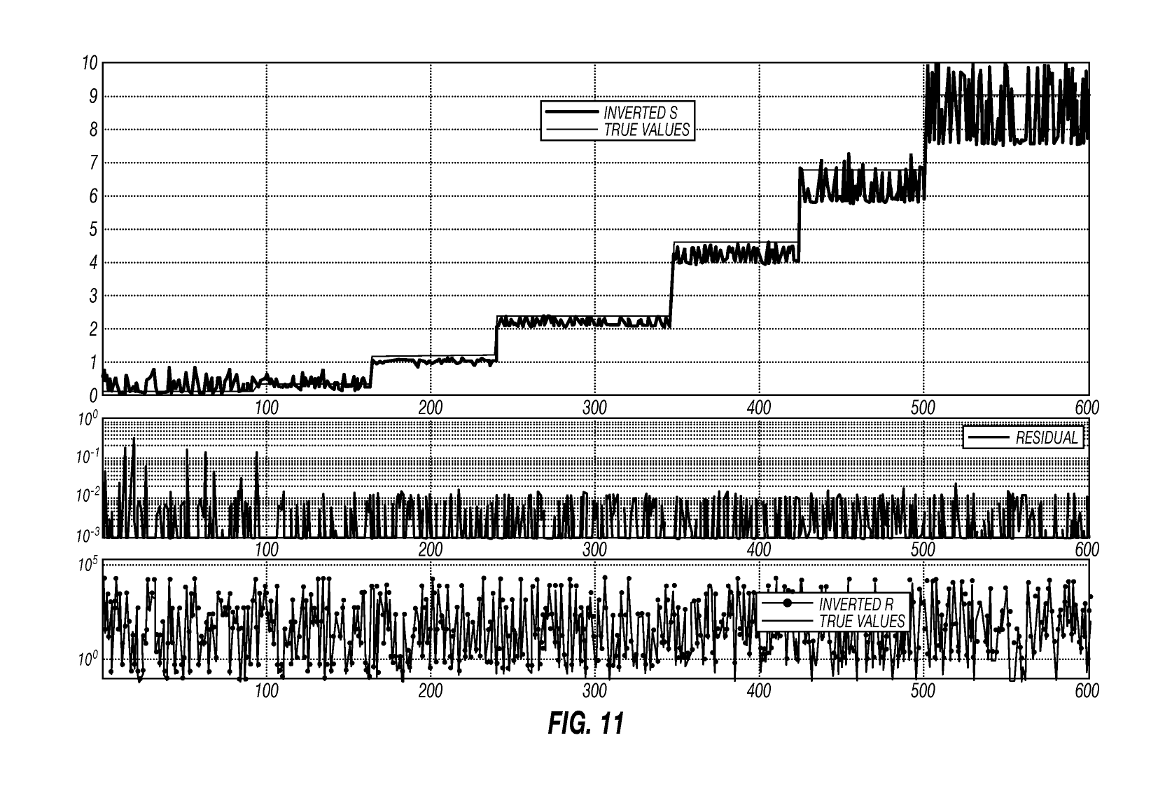

Performance of the inversion based workflow for the same resistivity profile from FIG. 6, but changed mud properties is illustrated on ordered standoff results. FIG. 10 shows results for ε_{M1}=17.1, ε_{M2}=17.1, ω_{M1}=−81°, ω_{M2}=−73°, where inverted values of mud properties are ε_{M1}=15.8, ε_{M2}=15.8, ω_{M1}=−81.1°, ω_{M2}=−72.1°. Similarly, in FIG. 11, the results for ε_{M1}=17.1, ε_{M2}=10, φ_{M1}=−81°, ω_{M2}=−65° has inverted values of mud properties of ε_{M1}=14.8, ε_{M2}=9.3, ω_{M1}=−81.6°, ω_{M2}=−65.5°. The results plotted in FIG. 11 are comparable to those in FIG. 6.

In some embodiments, the inverted standoff can be a useful quality indicator of the composite image, and may provide information about the borehole shape, drilling marks and fractures, and whether they are opened or closed. For example, the inverted standoff image may be compared with the inverted resistivity image, and this comparison may be used to indicate the quality and/or accuracy of the composite image.

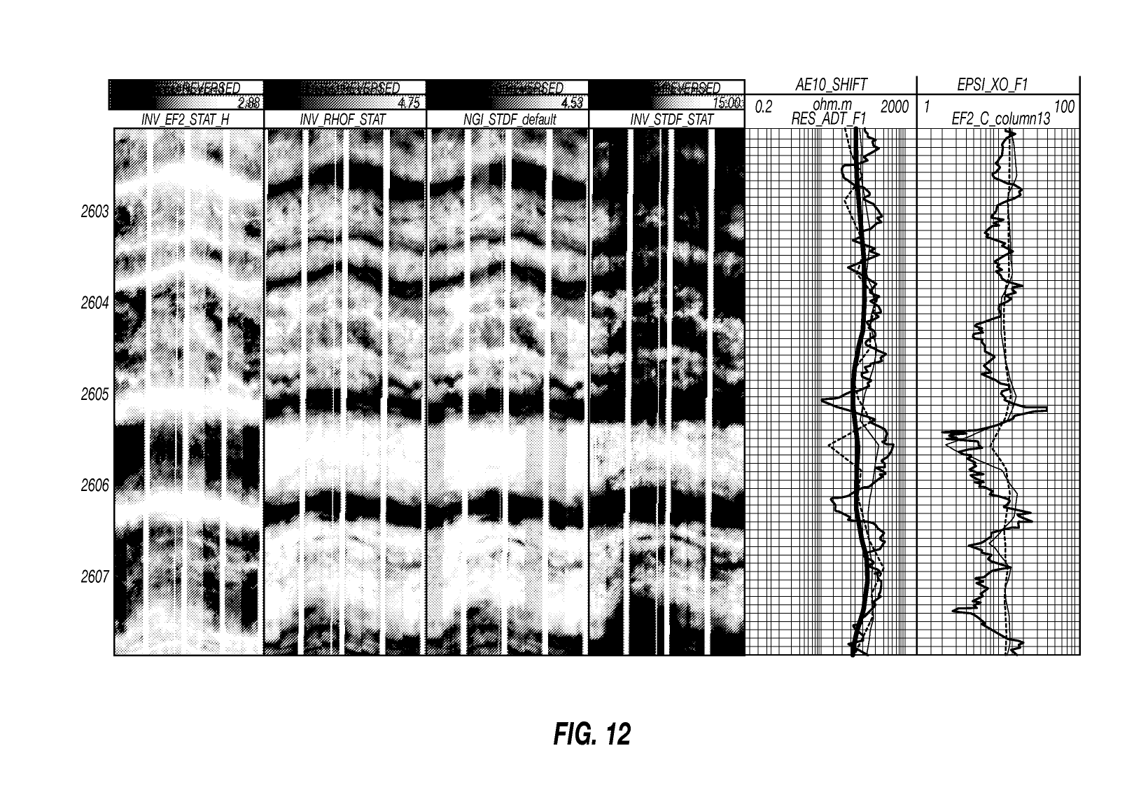

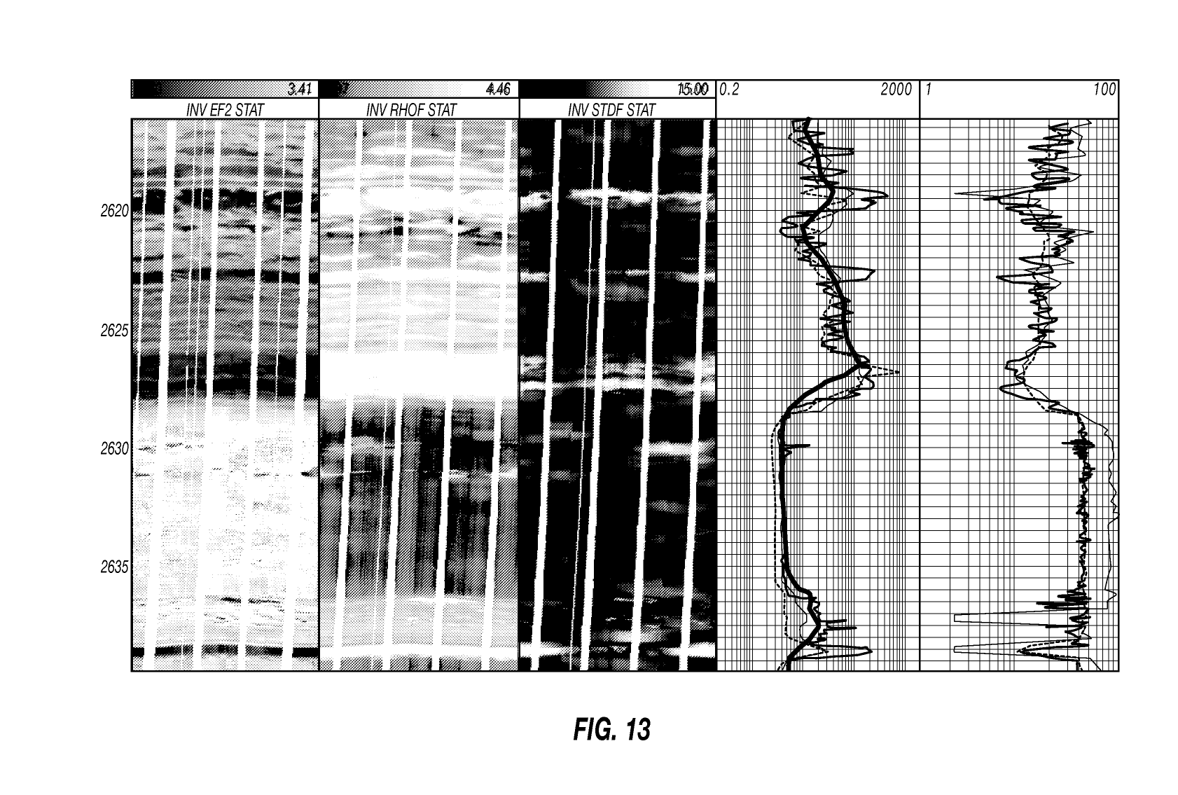

FIGS. 12 and 13 show the inverted formation resistivity, permittivity and standoff for two data sections acquired in the same well. In addition to the inversion generated images, the logs of the formation resistivity and permittivity may be compared to resistivity and permittivity at the two lowest frequencies of the dielectric measurements and the shallow resistivity curve of the array induction tool. The consistency between the measured resistivities for all 3 tools and the permittivity values may be determined The inversion-derived permittivity and resistivity is consistent with dielectric tool interpretation at the two lowest frequencies, showing more details due to much higher resolution. FIG. 12 shows the images and logs from a 10-ft. sections including a resistive zone where the dielectric effect is strong and composite processing has some lateral inconsistencies between pads primarily due to blending and partly due to dielectric effect. The inverted resistivity and high frequency dielectric permittivity images are more consistent. FIG. 13 is a plot of the results from a 20-ft. section including a less resistive zone. Inverted permittivity images are consistent over a wide range of resistivity, even for values as low as 4 Ωm.

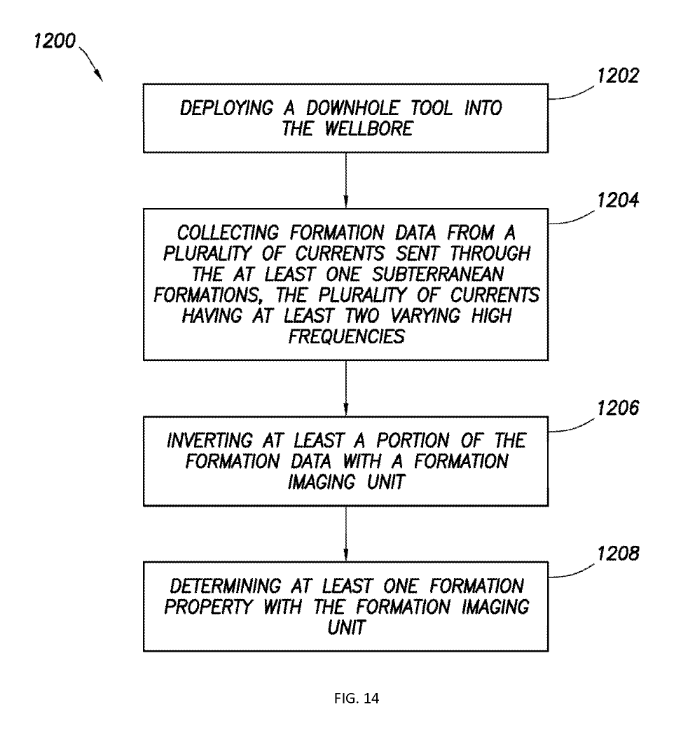

FIG. 14 depicts a flow diagram 1200 illustrating a method for imaging properties of at least one subterranean formation 136 in the wellbore 106 (as shown in FIG. 1). The flow begins by deploying 1202 a downhole tool into the wellbore. The downhole tool may be any of the downhole tools described herein and may include one or more sensors 120. The flow continues by collecting 1204 formation data from a plurality of currents sent through the at least one subterranean formation, the plurality of currents having at least two varying, or different, high frequencies. The flow continues by inverting 1206 at least a portion of the formation data with a formation imaging unit and determining 1208 at least one formation property with the formation imaging unit.

While the embodiments are described with reference to various implementations and exploitations, it will be understood that these embodiments are illustrative and that the scope of the inventive subject matter is not limited to them. Many variations, modifications, additions and improvements are possible. For example, additional sources and/or receivers may be located about the wellbore to perform seismic operations.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A formation imaging unit for imaging properties of at least one subterranean formation in a wellbore at a wellsite, the formation imaging unit comprising:
a current management unit for collecting data from at least two currents injected into the at least one subterranean formation, the at least two currents having at least two different frequencies;
a formation data unit for determining at least one formation parameter from the collected data; and
an inversion unit for inverting the at least one formation parameter to provide one or more of an inverted standoff image and an inverted permittivity image.

2. The formation imaging unit of claim 1, wherein the inversion unit is suitable for providing an inverted resistivity image and for comparing the inverted resistivity image with the inverted standoff image.

3. The formation imaging unit of claim 2, wherein the inversion unit is suitable for determining a quality of a composite image based on the comparison of the inverted resistivity image with the inverted standoff image.

4. The formation imaging unit of claim 1, wherein the current management unit is suitable for collecting data from the at least two currents injected into the at least one subterranean formation and at least a portion of mud in the wellbore.

5. The formation imaging unit of claim 1, comprising a mud data unit for determining at least one mud parameter from the collected data.

6. The formation imaging unit of claim 4, wherein the inversion unit is suitable for inverting the at least one mud parameter to determine one or more of the inverted standoff image and the inverted permittivity image.

7. A system for imaging properties of subterranean formation in a wellbore at a wellsite, the system comprising:
a formation sensor for collecting currents injected into the subterranean formation and wellbore fluid in the wellbore, the formation sensor positionable on a downhole tool deployable into the wellbore; and
a formation imaging unit, the formation imaging unit comprising:
a current management unit for collecting data from the currents injected into the subterranean formation and the wellbore fluid;
a data unit for determining a formation parameter, a mud parameter, or both, from the collected data; and
an inversion unit for inverting the formation parameter, the mud parameter, or both, to provide an inverted standoff image, an inverted permittivity image, or both.

8. The system of claim 7, wherein a first portion of the formation imaging unit is coupled to the downhole tool and operable in the wellbore and a second portion of the formation imaging unit is operable from a surface of the wellsite, and wherein the first portion and the second portion are suitable for communication therebetween.

9. The system of claim 7, wherein the formation imaging unit is suitable for providing an inverted resistivity image.

10. The system of claim 9, wherein the formation imaging unit is suitable for comparing the inverted standoff image, the inverted permittivity image, or both, with the inverted resistivity image image, and outputting a quality indicator based on the comparison.

11. The system of claim 10, wherein the formation imaging unit is suitable for iteratively inverting for the formation parameter, the mud parameter, or both.

12. The system of claim 11, wherein the formation imaging unit is suitable for iteratively comparing the inverted standoff image, the inverted permittivity image, or both, with the composite image, and iteratively outputting the quality indicator based on the comparison.

13. The system of claim 7, wherein the downhole tool comprises a wireline logging tool deployable by wireline into the wellbore.

14. The system of claim 7, wherein the downhole tool comprises a logging while drilling (LWD) tool, a measurement while drilling (MWD) tool, or any other suitable drilling tool conveyable in a drill string into the wellbore.

15. A method for imaging properties of at least one subterranean formation in a wellbore at a wellsite, the method comprising:
deploying a downhole tool into the wellbore, the downhole tool having a formation sensor thereon;
collecting at least two currents sent through the at least one subterranean formation from the formation sensor;
sending formation data from the at least two currents to a formation imaging unit;
performing an inversion at the formation imaging unit, wherein performing the inversion comprises generating an inverted standoff image, an inverted permittivity image, or both; and
determining at least one formation property with the formation imaging unit, based on the inverted standoff image, the inverted permittivity image, or both.

16. The method of claim 15, comprising performing an inversion at the formation imaging unit on the formation data to generate an inverted resistivity image.

17. The method of claim 16, comprising comparing the inverted standoff image, the inverted permittivity image, or both, with the inverted resistivity image.

18. The method of claim 17, comprising evaluating one or more of a wellbore rugosity, a quality of a composite image representative of the formation, fracture characteristics, geo-mechanics of the wellbore, rock strength of the formation, fault slips, and side-wall coring positions based on the inverted standoff image, a comparison of the inverted standoff image with the inverted resistivity image, or both.

19. The method of claim 18, comprising evaluating fractures based on the inverted standoff image, wherein evaluating fractures comprises determining whether the fractures are open or closed.

20. The method of claim 17, comprising evaluating fluid types of formation based on the inverted permittivity image, a comparison of the inverted permittivity image with the inverted resistivity image, or both.
